(19) United States
(12) Patent Application Publication
(10) Pub. No.: US 2015/0267836 A1
(43) Pub. Date: Sep. 24, 2015

(54) SOLENOID VALVE FOR FUEL CELL SYSTEM

(71) Applicant: Hyundai Motor Company, Seoul (KR)

(72) Inventors: Hyun Joon Lee, Yongin (KR); Bu Kil Kwon, Suwon (KR)

(21) Appl. No.: 14/535,679

(22) Filed: Nov. 7, 2014

(30) Foreign Application Priority Data
Mar. 24, 2014 (KR) 10-2014-0034289

(51) Int. Cl. F16K 31/06

(52) U.S. Cl. CPC F16K 31/0686

(57) ABSTRACT

A solenoid valve for a fuel cell system is provided that includes a valve housing and a valve body disposed within the valve housing having an inflow passage through which hydrogen flows in, a discharge passage through which hydrogen is discharged, and a valve passage connecting the inflow passage and the discharge passage. A solenoid is disposed within the valve housing and a plunger is supported within the solenoid by a valve spring. and the plunger is movable upward and downward while corresponding to the direction of the valve passage. A pressure balance unit is disposed extraneous to the plunger to press the plunger with force corresponding to excessive pressure greater than a determined inflow hydrogen pressure applied through a branch passage that branches off from the inflow passage.

### CROSS-REFERENCE TO RELATED APPLICATION(S)

Pursuant to 35 U.S.C. §119(a), this application claims the benefit of Korean Patent Application No. 10-2014-0034289 filed on Mar. 24, 2014, which is incorporated herein in its entirety.

### BACKGROUND

1. Field of the Invention

The present invention relates to a fuel cell system, and more particularly, to a solenoid valve for a hydrogen supply device which supplies high-pressure hydrogen, stored in a hydrogen storage tank, to a stack.

2. Description of the Related Art

A fuel cell system is a type of electric power generation system that is supplied air including oxygen and hydrogen used as fuel. Fuel cell systems generate electrical energy by an electrochemical reaction between the hydrogen and the oxygen. In addition, the fuel cell system is often adopted for a fuel cell-equipped vehicle, and such an electricity generating system drives the vehicle by powering a drive motor using the supplied electrical energy.

The fuel cell system includes an electricity generating assembly called a stack. A stack includes a plurality of unit fuel cells that have air electrodes and fuel electrodes, an air supply device configured to supply air to the air electrode of the fuel cell, and a hydrogen supply device configured to supply hydrogen to the fuel electrode of the fuel cell. In operation, the stack is configured to discharge air, including moisture, from the air electrode of the fuel cell, and discharge unreacted hydrogen, including moisture, from the fuel electrode of the fuel cell.

Further, the hydrogen supply device includes a hydrogen storage tank that stores hydrogen, at a predetermined pressure, and supplies the hydrogen to the fuel electrode of the fuel cell. In addition, the fuel cell system includes a hydrogen recirculation unit used as an ejector (also referred to as “a jet pump”) for mixing hydrogen supplied from the hydrogen storage tank and unreacted hydrogen discharged from the stack, and recirculating the mixed hydrogen to the stack. The hydrogen recirculation unit is configured to serve hydrogen supplied from the hydrogen storage tank using a nozzle to generate vacuum pressure, extract unreacted hydrogen discharged from the stack using vacuum pressure, and recirculate the hydrogen to the stack.

In general, a pressure of about 700 bars for the hydrogen stored in the hydrogen storage tank is adjusted to about 10 bars while hydrogen passes through a high-pressure regulator. The hydrogen may flow into the stack via the hydrogen recirculation unit when pressure has been adjusted by a hydrogen supply valve. When hydrogen at excessive pressure flows into the stack due to a failure of valves, regulators or the like, a membrane-electrode assembly (MEA) may be damaged due to a pressure difference in the stack. Damage to the membrane-electrode assembly may cause a risk of fire by a reaction between hydrogen and oxygen.

To prevent the aforementioned problems, safety apparatuses are installed into the hydrogen supply route of the hydrogen supply device in fuel cell systems. Such safety apparatuses may include high pressure relief valves, low pressure relief valves, hydrogen cut-off valves (e.g., solenoid valves), and the like. For example, since hydrogen at excessive pressure may flow into the stack when a high-pressure regulator malfunctions, a high-pressure relief valve blocks hydrogen at a pressure greater than or equal to a specific pressure (e.g., 15 to 20 bars) from flowing into the stack. Further, at arear side of the high-pressure relief valve, hydrogen at excessive pressure is secondarily blocked from flowing into the stack by the hydrogen cut-off valve.

However, since the high-pressure and low-pressure relief valves in the related art are mechanically operated by springs, there remains a risk that hydrogen may leak due to mechanical malfunction. This problem may cause other problems involving deterioration in vehicle fuel efficiency and hydrogen-related dangers in the fuel cell system. In addition, although the high-pressure relief valve is installed on the hydrogen supply route in the related art, there is a risk that hydrogen at excessively high pressure may flow into the stack while the pressure of hydrogen overcomes the elastic force of the hydrogen cut-off valve spring when hydrogen flows in at excessive pressure. Accordingly, the solenoid force of the hydrogen cut-off valve should be increased to prevent the aforementioned problem, but such a solution may cause an increase in volume of the entire valve, as well as undesirable operational noise.

The foregoing is intended merely to aid in the understanding of the background of the present invention, and is not intended to mean that the present invention falls within the purview of the related art that is already known to those skilled in the art.

### SUMMARY

The present invention provides a solenoid valve for a fuel cell system capable of reducing or preventing a flow of hydrogen at excessive pressure (e.g., higher than a predetermined inflow pressure) from flowing to the stack of a fuel cell system at a hydrogen supply route through which hydrogen is supplied to a stack.

An exemplary embodiment of the present invention provides a solenoid valve for a fuel cell system, which is a hydrogen cut-off valve installed on a hydrogen supply route of the fuel cell system. The solenoid valve may include a valve housing, and a valve body disposed within the valve housing. The valve body may include an inflow passage through which hydrogen may flow into the valve body . The solenoid may further include a discharge passage through which hydrogen may be discharged and a valve passage to connect the inflow passage and the discharge passage.

Further, the solenoid valve may include a solenoid disposed within the valve housing and a plunger supported within the solenoid by a valve spring, and which may be movable upward and downward while corresponding to a direction of the valve passage (e.g., upward and downward directions corresponding to the direction of a vertically-oriented valve passage). The solenoid valve may further include a pressure balance unit attached extraneous to the plunger and configured to press the plunger with force corresponding to excessive pressure when pressure exceeding a determined inflow pressure of hydrogen is applied through a branch passage that may be connected to the inflow passage.

In addition, according to an exemplary embodiment of the present invention, a solenoid valve for a fuel cell system may include a connecting passage formed within the valve housing and connected with the branch passage. The pressure balance unit may include: a diaphragm disposed at an upper end of the connecting passage, and adapted to be elastically deformed by excessive hydrogen pressure. An operation rod may be connected to an upper surface of the diaphragm and a lever member may be pivotably coupled to the solenoid, and may have a first end portion connected to the operation rod, and a second end portion through which the plunger may be pressed. In addition, the lever member which may be pivotably coupled to the solenoid may be a lever. The lever member may be pivotably coupled to a pivot coupling protrusion on the solenoid by a pivot shaft.

Furthermore, when a length between the pivot coupling point and the first end portion of the lever member is L1, and a length between the pivot coupling point and the second end portion of the lever member is L2 based on a pivot coupling point with the solenoid, wherein the length L2 may be greater than the length L1.

The solenoid valve may be adapted such that P4+P3 >P1 where P1 equals a hydrogen pressure applied to the plunger through the inflow passage, P2 equals excessive pressure applied to the operation rod through the branch passage and the connecting passage equals, P3 equals a first force applied to the plunger through the second end portion of the lever member, and P4 equals a second force applied to the plunger through the valve spring.

Additionally, a pressing protrusion, adapted to press an upper surface of the plunger, may be integrally formed at the second end portion of the lever member. The lever member may have a first end portion and a second end portion, the first end portion disposed between a first end of the lever member and a pivot coupling point and a second end portion disposed between the pivot coupling point and the second end of the lever member. The first portion may be disposed in a horizontal direction, and the second portion may be disposed at an incline relative to the horizontal direction, (e.g., an upward incline relative to the horizontal direction).

Another exemplary embodiment of the present invention provides a solenoid valve for a fuel cell system, which may include a valve housing, a valve body disposed within the valve housing, wherein the valve body may include an inflow passage through which reaction gas may flow, a discharge passage through which reaction gas may be discharged, and a valve passage to connect the inflow passage and the discharge passage. The solenoid valve may further include a solenoid disposed within the valve housing, a plunger supported within the solenoid by a valve spring, and which may be movable upward and downward corresponding to the direction of the valve passage, (e.g., upward and downward directions corresponding to the direction of a the valve passage), a branch passage which may branch off from the inflow passage; a diaphragm disposed at an upper end of a connecting passage of the valve housing and connected with the branch passage, and elastically deformed by excessive reaction gas pressure; an operation rod connected to an upper surface of the diaphragm; and a lever member pivotably coupled to the solenoid, and having a first end portion connected to the operation rod, and a second end portion through which the plunger may be pressed. A hydrogen cut-off valve may be installed on a hydrogen supply route of the fuel cell system.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary, partially cut-out perspective view schematically illustrating a solenoid valve for a fuel cell system according to an exemplary embodiment of the present invention;

FIG. 2 is an exemplary cross-sectional schematic diagram schematically illustrating the solenoid valve for a fuel cell system according to the exemplary embodiment of the present invention:

FIGS. 3A and 3B are exemplary views illustrating a lever member of a pressure balance that is applied to the solenoid valve for a fuel cell system according to the exemplary embodiment of the present invention; and

FIG. 4 is an exemplary view illustrating an operation of the solenoid valve for a fuel cell system according to the exemplary embodiment of the present invention.

### DESCRIPTION OF SYMBOLS

10 . . . Valve housing

17 . . . Connecting passage

20 . . . Valve body

21 . . . Inflow passage

23 . . . Discharge passage

25 . . . Valve passage

27 . . . Branch passage

30 . . . Solenoid

33 . . . Pivot coupling protrusion

40 . . . Plunger

41 . . . Valve spring

50 . . . Pressure balance unit

51 . . . Diaphragm

61 . . . Operation rod

71 . . . Lever member

73 . . . Pivot shaft

75 . . . Pressing protrusion

77 . . . First portion

79 . . . Second portion

100 Solenoid valve

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Specific structural and functional descriptions of exemplary embodiments of the present invention disclosed herein are only for illustrative purposes of the exemplary embodiments of the present invention. The present invention may be embodied in many different forms without departing from the spirit and significant characteristics of the present invention. Therefore, the exemplary embodiments of the present invention are disclosed only for illustrative purposes and should not be construed as limiting the present invention.

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention. A part irrelevant to the description will be omitted to clearly describe the present invention, and the same or similar constituent elements will be designated by the same reference numerals throughout the specification. The size and thickness of each component illustrated in the drawings are arbitrarily shown for understanding and ease of description, but the present invention is not limited thereto. Thicknesses of several portions and regions are enlarged for clear expressions. Further, in the following detailed description, names of constituents, which are in the same relationship, are divided into “the first”, “the second”, and the like, but the present invention is not necessarily limited to the order in the following description.

In addition, the term “unit”, “means”, “part”, “member”, or the like, which is described in the specification, means a unit of a comprehensive configuration that performs at least one function or operation.

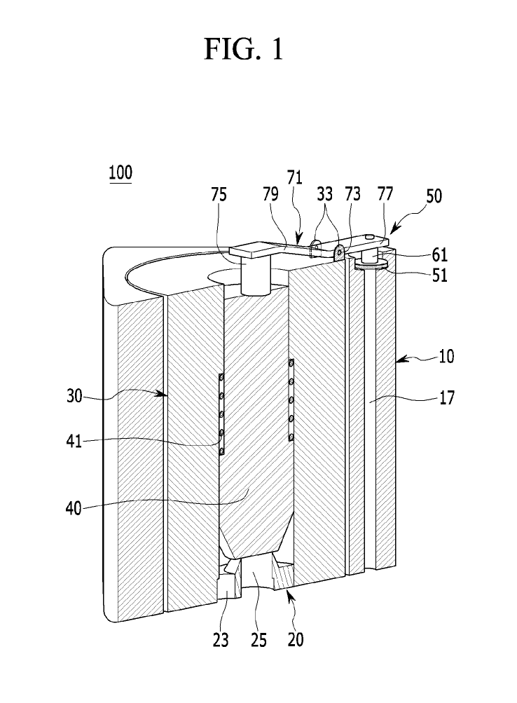

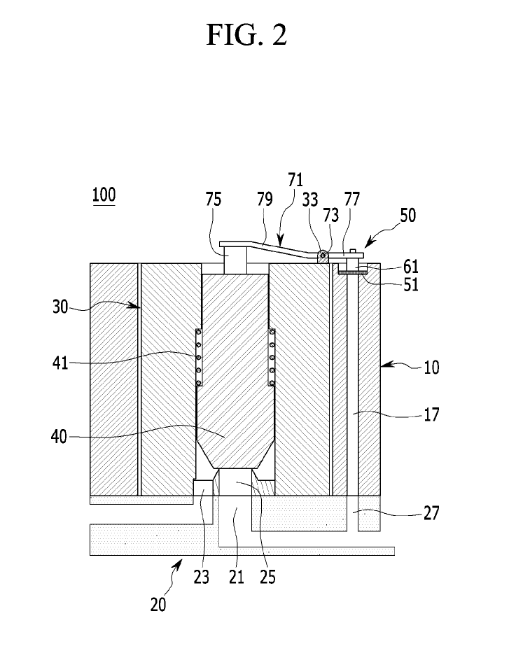

Hereinafter, an exemplary solenoid valve for a fuel cell according to the present invention will be described in detail with reference to the accompanying drawings. FIG. 1 is an exemplary, partially cut-out, view schematically illustrating a solenoid valve for a fuel cell system according to an exemplary embodiment of the present invention, and FIG. 2 is an exemplary cross-sectional schematic diagram schematically illustrating the solenoid valve for a fuel cell system according to an exemplary embodiment of the present invention.

Referring to FIGS. 1 and 2, a solenoid valve 100 according to an exemplary embodiment of the present invention may be used in a fuel cell system that produces electrical energy by an electrochemical reaction between hydrogen, as reaction gas, and air. For example, the fuel cell system according to an exemplary embodiment of the present invention may be used in a fuel cell vehicle that operates a drive motor using electrical energy and operates wheels of the vehicle using the driving power of the drive motor.

The fuel cell system according to exemplary embodiments may include a stack, a hydrogen supply device, and an air supply device. The stack is an electricity generating assembly of fuel cells having air electrodes and fuel electrodes. The stack may be supplied, directly or indirectly with hydrogen supplied from the hydrogen supply device, and air from the air supply device, to generate electrical energy by an electrochemical reaction between hydrogen and oxygen. Further, the hydrogen supply device may include a hydrogen storage tank configured to store hydrogen gas and supply the hydrogen gas to the stack. The air supply device may include an air compressor or an air blower configured to supply air to the stack.

The solenoid valve 100 may be configured to supply hydrogen to the stack and may be disposed on a hydrogen supply route through which a pressure of hydrogen, (e.g., the high-pressure reaction gas stored in the hydrogen storage tank), may be adjusted to a predetermined pressure, to supply hydrogen to the stack. A high-pressure regulator configured to adjust and select the hydrogen pressure, a high-pressure cut-off valve, a high-pressure/low-pressure relief valve, a hydrogen supply valve, and the like may also be disposed on the hydrogen supply route. Further, a hydrogen recirculation unit may be disposed on the hydrogen supply route. The hydrogen recirculation unit may be configured to mix hydrogen supplied from the hydrogen storage tank with unreacted hydrogen discharged from the stack and recirculate the mixture to the stack.

The solenoid valve 100 may be a hydrogen cut-off valve configured to block hydrogen at excessive pressure from flowing into the stack in an auxiliary manner when there is a malfunction in one or more of the high-pressure regulator, the valves or the like, on the hydrogen supply route.

Moreover, the solenoid valve 100 may be used in a general vehicle, a hybrid vehicle, and an electric vehicle. Hereinafter, a solenoid valve 100, disposed on a hydrogen supply route in a fuel cell system of a fuel cell vehicle, will be described as an example. However, it should be understood that the scope of the present invention is not necessarily limited thereto, and the technical spirit of the present invention may be applied to any other solenoid valves adopted for various types of fluid supply structures for various uses.

The solenoid valve 100 for a fuel cell system according to an exemplary embodiment of the present invention may have a structure that may maintain air-tightness (e.g., an air seal) using a simplified configuration and prevent hydrogen, at excessive pressure (e.g., pressure greater than a predetermined pressure), from flowing into the stack, even though hydrogen, at excessive pressure, may flow when the hydrogen supply route is shut off when any or all of the high-pressure regulator, the valves, and the like malfunction. Accordingly, the solenoid valve 100 for a fuel cell system according to an exemplary embodiment of the present invention may include a valve housing 10, a valve body 20, a solenoid 30, a plunger 40, and a pressure balance unit 50. The valve housing 10 may be a valve case that may define an external appearance of the valve. The valve body 20 may include an inflow and outflow passage for hydrogen, and may be installed within the valve housing 10. The solenoid 30 may be installed within the valve housing 10. Electricity may be used within the solenoid unit 30 to generate an electromagnetic force to drive the solenoid unit 30.

Further, the plunger 40 may be elastically supported within the solenoid 30 by a valve spring 41, and may be installed to be reciprocally movable upward and downward. It should be noted that the reciprocal movement of valve spring 41 may occur in any opposite directions; upward and downward are merely illustrative examples and used only for the sake of explanation. Exemplary embodiments of the present invention contemplate movement that may be side to side or at oblique angles relative to a horizon is within the scope of the present invention. The plunger 40 may be moved upward by electromagnetic force while overcoming elastic force of the valve spring 41 when electric power is applied to the solenoid 30, and may be moved downward by elastic restoring force of the valve spring 41 when electric power supplied to the solenoid 30 is shut off.

As illustrated in FIGS. 1 and 2, the valve body 20 may have an inflow passage 21 through which hydrogen flows into the body 20, a discharge passage 23 through which hydrogen is discharged from the body 20, and a valve passage 25 that connects the inflow passage 21 and the discharge passage 23. In particular, when electric power is applied to the solenoid 30, the plunger 40 may be configured to open the valve passage 25 while being moved upward by an electromagnetic force, and when electric power applied to the solenoid 30 is shut off, the plunger 40 may be configured to close the valve passage 25 while being moved downward by the valve spring 41. Since the aforementioned configurations of the valve housing 10, the valve body 20, the solenoid 30, and the plunger 40 are basic configurations of the solenoid valve which have been widely known to the corresponding industrial field, more detailed descriptions of detail structures and coupling structures of the configurations will be omitted in the present specification.

Moreover, the pressure balance unit 50 may have a structure that applies additional pressing force to the plunger 40 in addition to elastic force of the valve spring 41, when the high-pressure regulator, the valves, and the like break down or malfunction, and hydrogen at excessive pressure greater than a predetermined inflow pressure may flow in through the inflow passage 21 of the valve body 20 even when the hydrogen supply route is shut off.

The valve body 20 may include a branch passage 27 that branches off from the inflow passage 21, and a connecting passage 17, connected with the branch passage 27 formed in the valve housing 10. As is shown in FIGS. 1 and 2, the connecting passage 17 may penetrate the valve housing 10 in a vertical direction (e.g., upward and downward directions).

In an exemplary embodiment of the present invention, the pressure balance unit 50 may be disposed extraneous to the plunger 40, and when excessive pressure, which may be greater than a predetermined inflow pressure of hydrogen, is applied through the branch passage 27 and the connecting passage 17, the pressure balance unit 50 may be configured to press the plunger 40 with force that corresponds to the excessive pressure. The pressure balance unit 50 may include a diaphragm 51, an operation rod 61, and a lever member 71. The diaphragm 51 may be disposed at an upper end portion of the aforementioned connecting passage 17. The diaphragm 51 may be elastically deformed by excessive pressure of hydrogen that flows into the connecting passage 17 through the branch passage 27. Since the diaphragm 51 may be formed as known by those skilled in the art, a more detailed description of the configuration will be omitted in the present specification for the sake of brevity.

The operation rod 61 may be moved (e.g., operated) upward and downward (e.g., in vertical directions) at the upper end portion side of the connecting passage 17 by the diaphragm 51 elastically deformed by excessive hydrogen pressure. The operation rod 61 may be connected to an upper surface of the diaphragm 51. Further, the lever member 71 may be pivotably coupled to the solenoid 30 extraneous to the plunger 40. The lever member 71 may be a lever type, and may be pivotably coupled to the solenoid 30.

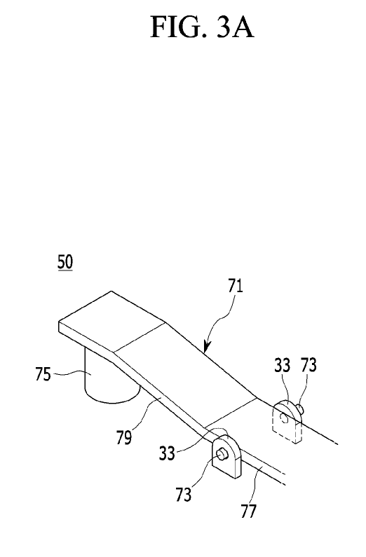

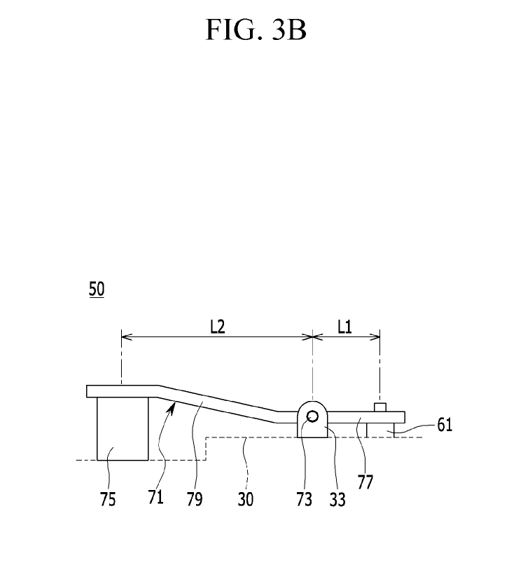

FIGS. 3A and 3B are exemplary views illustrating the lever member 71 of the pressure balance unit 50 that may be applied to the solenoid valve 10 for a fuel cell system according to an exemplary embodiment of the present invention. Referring to FIGS. 1 to 3, the lever member 71 may be pivotably coupled on the solenoid 30 via pivot shafts 73. The pivot shafts 73 may form pivot coupling points of the lever member 71 to the solenoid 30, and may be formed to protrude at both sides of the lever member 71. The pivot shafts 73 may be pivotably coupled to a pair of pivot coupling protrusions 33 that protrude from the solenoid 30.

Further, one end portion (e.g., a first end) of the lever member 71 may be connected to an upper end portion of the aforementioned operation rod 61, and the other end portion (e.g., a second end) of the lever member 71 may be configured to press an upper surface of the plunger 40. A pressing protrusion 75, which may substantially press the upper surface of the plunger 40, may be integrally formed at the other end portion of the lever member 71.

The aforementioned lever member 71 may be pivotably coupled to the pivot coupling protrusions 33 of the solenoid 30 in a lever type by the pivot shafts 73. Therefore, when the diaphragm 51 is elastically deformed by excessive hydrogen pressure of hydrogen that flows into the connecting passage 17 through the branch passage 27, force directed toward the upper side, may be applied to one end portion of the lever member 71 by the operation rod 61, and force directed toward the plunger 40, may be applied to the other end portion of the lever member 71.

In an exemplary embodiment of the present invention, when a length between the pivot coupling point and a first end portion is L1 and a length between the pivot coupling point and a second end portion is L2, based on the pivot coupling point with the solenoid 30, the lever member 71 may be pivotably coupled to the solenoid 30 while satisfying L2>L1. Accordingly, the lever member 71 may be pivotably coupled to the solenoid 30 under the L2>L1 condition to provide rotational force, which may have greater than rotational force to the first end portion of the lever member 71, to the second end portion of the lever member 71.

The aforementioned lengths L1 and L2 of the lever member 71 may be varied based on a position of the pivot coupling point between the lever member 71 and the solenoid 30, and the lengths L1 and L2 may be determined based on elastic force of the valve spring 41. The first portion 77 of lever member 71, and the second portion 79 of lever member 71, may be defined by a placement of a pivot coupling point for lever member 71 which may be disposed within pivot coupling protrusion 33. According to an exemplary embodiment of the present invention, the first portion 77 may be disposed in a horizontal direction, and the second portion 79 may disposed to be inclined upward, relative to the horizontal direction. Such a configuration may increase mechanical lifting force applied to the plunger 40 through the second end portion 79 of the lever member 71, by increasing a length of the aforementioned pressing protrusion 75.

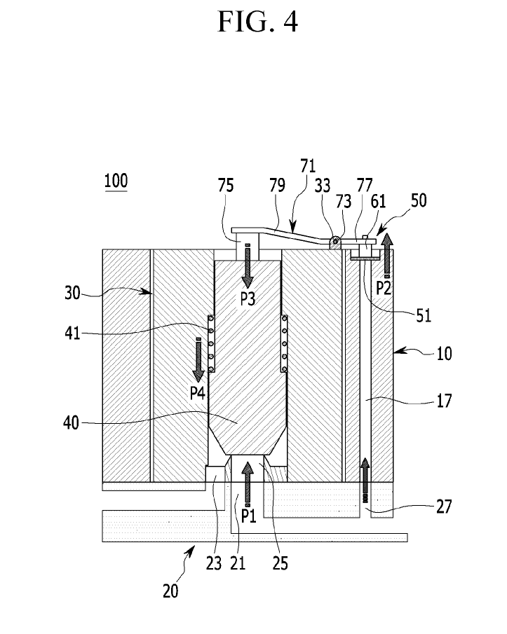

Hereinafter, an operation of the solenoid valve 100 for a fuel cell system according to the exemplary embodiment of the present invention, which is configured as described above, will be described in detail with reference to the previously disclosed drawings and the accompanying drawing. FIG. 4 is an exemplary view of the present invention illustrating an operation of the solenoid valve 100 for a fuel cell system according to an exemplary embodiment of the present invention. When hydrogen stored in the hydrogen storage tank is supplied to the stack through the hydrogen supply route when the high-pressure regulator, the valves, and the like operate without failure, electric power may be applied to the solenoid 30. Then, the plunger 40 may be moved upward by an electromagnetic force generated by the solenoid 30 while overcoming elastic force of the valve spring 41, thus opening the valve passage 25 of the valve body 20. Therefore, hydrogen that flows into the inflow passage 21 of the valve body 20, may be discharged to the discharge passage 23 through the valve passage 25, and may be supplied to the stack through the hydrogen recirculation unit.

Further, hydrogen stored in the hydrogen storage tank may be supplied to the stack through the hydrogen recirculation unit when hydrogen pressure is adjusted to a predetermined pressure through the high-pressure regulator, the valves, and the like. Meanwhile, according to an exemplary embodiment of the present invention, when the high-pressure regulator, the valves, and the like malfunction (e.g., experience a failure) during a process in which hydrogen stored in the hydrogen storage tank is supplied to the stack through the hydrogen supply route, electric power being applied to the solenoid 30 may be shut off. Then, the plunger 40 may be moved downward by elastic restoring force of the valve spring 41, and may be configured to close the valve passage 25. Therefore, hydrogen, which flows into the inflow passage 21 of the valve body 20, may not be discharged to the discharge passage 23 by the plunger 40.

Additionally, in an exemplary embodiment of the present invention, when hydrogen at an excessive pressure P1 flows into the inflow passage 21 of the valve body 20, the pressure P1 may be applied to the plunger 40, and hydrogen at excessive pressure, which flows into the inflow passage 21 of the valve body 20, flows into the branch passage 27, and elastically deforms the diaphragm 51 in the upward direction. Under this condition, the diaphragm 51 may be configured to move the operation rod 61 upward. Then, the operation rod 61 may be configured to apply excessive pressure P2 applied upward, to a first end portion of the lever member 71. Further, since the lever member 71 may be pivotably coupled on the solenoid 30, the lever member 71 may be configured to pivot about the pivot coupling point with the solenoid 30, and the second end portion 79 of the lever member 71 may be configured to apply a pressing force P3 to the plunger 40 through the pressing protrusion 75.

Therefore, according to an exemplary embodiment of the present invention, when hydrogen at an excessive pressure, greater than a predetermined inflow pressure, flows in through the inflow passage 21 of the valve body 20, an additional pressing force P3 applied by the lever member 71 may be applied to the plunger 40 in addition to elastic force P4 of the valve spring 41. In other words, since force, produced by adding the pressing force P3 of the lever member 71 and the elastic force P4 of the valve spring 41, may be applied to the plunger 40, the plunger 40 may not be moved upward by the pressure P1 of hydrogen, but may maintain air-tightness (e.g., an air seal) of the valve passage 25 even though the excessive pressure P1 of hydrogen is applied to the plunger 40.

Accordingly, in an exemplary embodiment of the present invention, even though hydrogen at an excessive pressure, greater than a predetermined inflow pressure, flows in through the inflow passage 21 of the valve body 20, air-tightness of the valve passage 25 may be maintained by the pressure balance unit 50 including the lever member 71, thereby preventing hydrogen at excessive pressure from flowing into the stack.

As described above, the use of the solenoid valve 100 for a fuel cell system according to an exemplary embodiment of the present invention, the risk of hydrogen at excessive pressure flowing into the stack may be reduced after malfunction of a high-pressure regulator, the valves, and the like, thereby preventing or reducing the risk of damage to a membrane-electrode assembly (MEA) caused by a pressure difference in the stack. Therefore exemplary embodiments of the present invention may help prevent a risk of fire due to such damage. Moreover, in an exemplary embodiment of the present invention, since hydrogen at excessive pressure may be prevented from flowing into the stack using the pressure balance unit 50 of a simplified configuration, a high-pressure relief valve or another safety apparatus used in the related art, may not be necessary and may be eliminated.

Accordingly, the use of a solenoid valve according to the exemplary embodiment of the present invention, may eliminate a need for some of the safety apparatuses such as the high-pressure relief valve, thereby reducing a package size and a volume of the entire fuel cell system, thereby reducing manufacturing costs.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A solenoid valve for a fuel cell system, which is a hydrogen cut-off valve installed on a hydrogen supply route of the fuel cell system, the solenoid valve comprising:
a valve housing;
a valve body disposed within the valve housing, the valve body having an inflow passage through which hydrogen flows in into the valve body, a discharge passage through which hydrogen is discharged, and a valve passage to connect the inflow passage and the discharge passage;
a solenoid disposed within the valve housing;
a plunger supported within the solenoid by a valve spring, the plunger movable upward and downward while corresponding to a direction of valve passage; and
a pressure balance unit disposed extraneous to the plunger, and configured to press the plunger with force that corresponds to an excessive pressure when pressure exceeding a determined inflow pressure of hydrogen is applied through a branch passage connected to the inflow passage.

2. The solenoid valve of claim 1; further comprising:
a connecting passage connected with the branch passage and formed within the valve housing.

3. The solenoid valve of claim 2, wherein the pressure balance unit includes:
a diaphragm disposed at an upper end of the connecting passage, and elastically deformed by excessive hydrogen pressure;
an operation rod connected to an upper surface of the diaphragm; and
a lever member pivotably coupled to the solenoid, and having a first end portion connected to the operation rod, and a second end portion through which the plunger is pressed.

4. The solenoid valve of claim 3, wherein the lever member is pivotably coupled to the solenoid.

5. The solenoid valve of claim 3, wherein the lever member is pivotably coupled to a pivot coupling protrusion on the solenoid by a pivot shaft.

6. The solenoid valve of claim 3, wherein when a length between the pivot coupling point and the first end portion of the lever member is L1, and a length between the pivot coupling point and the second end portion of the lever member is L2 based on a pivot coupling point with the solenoid, the lever member satisfies L2>L1.

7. The solenoid valve of claim 6, wherein when hydrogen pressure applied to the plunger through the inflow passage, is P1, excessive pressure applied to the operation rod through the branch passage and the connecting passage, is P2, force applied to the plunger through the second end portion of the lever member, is P3, and force applied to the plunger through the valve spring, is P4, P4+P3>P1 is satisfied.

8. The solenoid valve of claim 3, further comprising:
a pressing protrusion configured to press an upper surface of the plunger, the pressing protrusion integrally formed at the second end portion of the lever member.

9. The solenoid valve of claim 3, wherein the first end portion of the lever is disposed in a horizontal direction and the second end portion of the lever member is disposed to be inclined upward.

10. A solenoid valve for a fuel cell system, comprising:
a valve housing;
a valve body disposed within the valve housing, the valve body having an inflow passage through which reaction gas flows in, a discharge passage through which reaction gas is discharged, and a valve passage to connect the inflow passage and the discharge passage;
a solenoid disposed within the valve housing;
a plunger supported within the solenoid by a valve spring, and configured to be movable upward and downward while corresponding to a direction of the valve passage;
a branch passage which branches off from the inflow passage;
a diaphragm disposed at an upper end of a connecting passage of the valve housing and connected with the branch passage, and elastically deformed by excessive reaction gas pressure;
an operation rod connected to an upper surface of the diaphragm; and
a lever member pivotably coupled to the solenoid, having a first end portion connected to the operation rod, and a second end portion through which the plunger is pressed.

11. The solenoid valve of claim 10, wherein the solenoid valve is installed on a hydrogen supply route of the fuel cell system and is configured to cut off a supply of hydrogen to the fuel cell system.
